(19) United States
(12) Patent Application Publication
(10) Pub. No.: US 2015/0006306 A1
(43) Pub. Date: Jan. 1, 2015

(54) SYSTEM INCLUDING POS DEVICE AND METHOD FOR CONTROLLING SYSTEM INCLUDING POS DEVICE

(71) Applicant: NEC Infrontia Corporation, Kanagawa (JP)

(72) Inventor: Hidetada Nishimagi, Kanagawa (JP)

(73) Assignee: NEC INFRONTIA CORPORATION, Kanagawa (JP)

(21) Appl. No.: 14/375,100

(22) PCT Filed: Feb. 1, 2013
(86) PCT No.: PCT/JP2013/052956

§ 371 Date: Jul. 28, 2014

(30) Foreign Application Priority Data
Feb. 28, 2012 (JP) 2012-041501

(51) Int. Cl. G06Q 20/20

(52) U.S. Cl. CPC G06Q 20/202
USPC 705/21

(57) ABSTRACT

Provided are a system, a server, a method of controlling a system, and a method of controlling a server capable of enabling a user to perform a setup at a time of installing a new POS device in a store or at a time of relocating the POS device. The system includes: a server (10) installed in a supplier company; and POS devices (20) to be installed in stores of a user company and to be connected to the server (10) via a communication network. The POS device (20) includes: an input unit (23) for inputting an identification code for uniquely specifying the POS device (20); and a transmission/reception unit (24). The server (10) includes: a memory unit (11) for storing a table in which master data set for each of the stores of the user company is associated with the identification code; a reception unit (14) for receiving the identification code from the POS device (20); an identification section (12a) for referring to the table to specify master data associated with the received identification code; and a transmission unit (14) for transmitting the specified master data to the POS device (20).

### TECHNICAL FIELD

This invention relates to a system including a POS device, a server, a method of controlling a system including a POS device, and a method of controlling a server.

### BACKGROUND ART

There has been proposed an online POS device which includes an in-store central processing unit and a plurality of POS terminals both of which are connected via a transmission line. In such an online POS device, the in-store central processing unit has a memory storing a table in which a program number (NO) and a preset data number (NO) are stored for each register number (REGNO) or identification number (IDNO) of each POS terminal With this structure, when the in-store central processing unit performs down line loading, an inquiry is issued by the use of the program NO and the preset data NO associated with the REGNO or IDNO of the POS terminal of the table and thereafter the loading is performed (see, for example, Patent Literature 1).

### CITATION LIST

### Patent Literature

Patent Literature 1: JP-A-S58-086662

### DISCLOSURE OF THE INVENTION

### Problem to be Solved by the Invention

However, with the technology disclosed in Patent Literature 1, the user cannot perform, by himself/herself, a setup (operation of making the POS device available for use) at a time of installing a new POS device in a store or at a time of relocating the POS device. Under the circumstances, such a setup operation of the POS device cannot help relying on a person in charge of installation who is specialized in the installation or a system engineer.

Accordingly, for example, a cost of the installation of a new POS device or the relocation of the POS device arises, which poses a problem to the user, and the supplier company of the POS device needs to adjust a schedule of the installation work for the POS device, which poses a problem to the supplier company as well.

In view of the above, this invention has been made to solve the problem inherent in the above-mentioned technologies, and therefore has an object to provide a system, a server, a method of controlling a system, and a method of controlling a server capable of enabling a user to perform a setup at a time of installing a new POS device in a store or at a time of relocating the POS device.

### Means to Solve the Problem

A system according to this invention includes: a server installed in a supplier company of POS devices; and the POS devices to be installed in stores of a user company of the POS devices and to be connected to the server via a communication network, in which: each of the POS devices includes: an input unit for inputting an identification code for uniquely specifying the each of the POS devices; and a transmission/reception unit; and the server includes: a memory unit for storing a table in which master data set for each of the stores of the user company, is associated with the identification code; a reception unit for receiving the identification code from the each of the POS devices; an identification section for referring to the table to specify master data associated with the received identification code; and a transmission unit for transmitting the specified master data to the each of the POS devices.

Further, a server according to this invention which is to be installed in a supplier company of POS devices and is to be connected to the POS devices installed in stores of a user company of the POS devices via a communication network, the server includes: a memory unit for storing a table in which master data set for each of the stores of the user company is associated with an identification code for uniquely specifying each of the POS devices; a reception unit for receiving the identification code from the each of the POS devices; an identification section for referring to the table to specify master data associated with the received identification code; and a transmission unit for transmitting the specified master data to the each of the POS devices.

Further, a method of controlling system according to this invention, the system includes: a server installed in a supplier company of POS devices; and the POS devices installed in stores of a user company of the POS devices and connected to the server via a communication network, the method includes: transmitting, an identification code for uniquely specifying the each of the POS devices through a transmission/reception unit of each of the POS devices to the server; referring, by an identification section of the server, to a table stored in a memory unit of the server, in which master data set for each of the stores of the user company, is associated with the identification code, to specify master data associated with the identification code received from the each of the POS devices; and transmitting, by a transmission unit of the server, the specified master data to the each of the POS devices.

Further, a method of controlling a server according to this invention, the server being installed in a supplier company of POS devices and connected to the POS devices installed in stores of a user company of the POS devices via a communication network, the method includes: receiving, by a reception unit of the server, an identification code for uniquely specifying each of the POS devices from the each of the POS devices; referring, by an identification section of the server, to a table stored in a memory unit of the server, in which master data set for each of the stores of the user company is associated with the identification code, to specify master data associated with the identification code received from the each of the POS devices; and transmitting, by a transmission unit of the server, the specified master data to the each of the POS devices.

### Effect of the Invention

According to this invention, the user can perform the setup at the time of installing the new POS device in the store or at the time of relocating the POS device, and hence the cost of the installation of the new POS device or the relocation of the POS device can be reduced.

Moreover, the workload of the supplier company can be reduced, which benefits the supplier company of the POS device as well. For example, the supplier company does not need to adjust the schedule of the installation work.

### BRIEF DESCRIPTION OF THE DRAWING

FIG. 1 is a schematic diagram illustrating a system according to a first embodiment of this invention.

FIG. 2 is an explanatory diagram schematically illustrating configurations of a server, each POS device, and a terminal.

FIG. 3 is an explanatory diagram showing an example of information notified from a user company to a supplier company.

FIG. 4 is an explanatory diagram showing an example of a data structure of a table stored in a memory unit of the server.

FIG. 5 is an explanatory diagram showing a data structure of a table obtained after the table shown in FIG. 4 is modified.

FIG. 6 is a flow chart illustrating a processing flow executed in the system according to the first embodiment of this invention.

FIG. 7 is an explanatory diagram showing an example of a data structure of a table according to a second embodiment of this invention.

FIG. 8 is an explanatory diagram showing a data structure of a table obtained after the table shown in FIG. 7 is modified.

### MODE FOR EMBODYING THE INVENTION

Now, a description is given of systems according to a plurality of embodiments of this invention with reference to the drawings.

### Embodiments

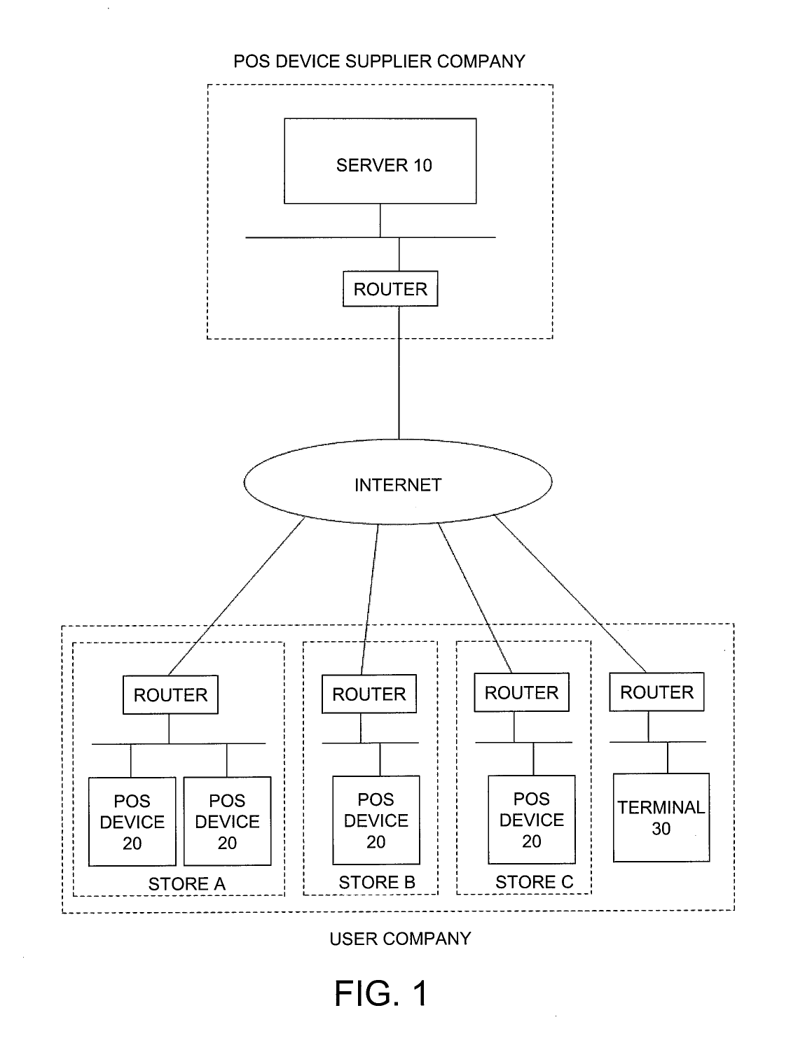

As illustrated in FIG. 1, a system according to a first embodiment of this invention includes at least a server 10 installed in a supplier company of point of sales (POS) devices 20, a plurality of POS devices 20 installed in each of the stores of a user company of the POS devices 20, and a terminal 30 which serves as an information processing terminal installed in the user company.

As illustrated in FIG. 1, the POS devices 20 and the terminal 30 are connected to the server 10 via the Internet line. Note that, a communication network for connecting the POS devices 20 and the terminal 30 to the server 10 is not limited to the Internet line, and may be any other type of communication network communication between the terminal 30 and the server 10 and communication between each of the POS devices 20 and the server 10 are encrypted by hardware and software (not shown).

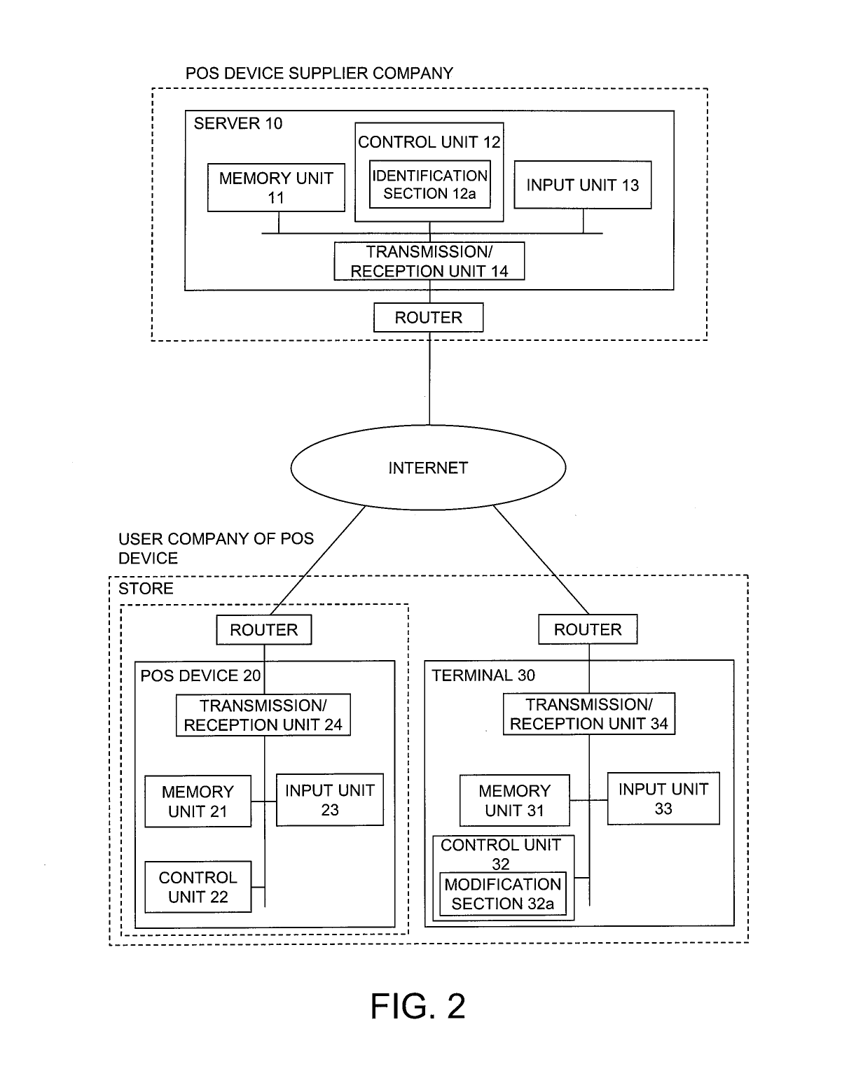

As illustrated in FIG. 2, the server 10 installed in the supplier company includes a memory unit 11, a control unit 12, an input unit 13, an output unit, a transmission/reception unit 14, auxiliary storage device, and others. The control unit 12 is configured by a CPU or the like, and the memory unit 11 is configured by a ROM, a RAM, a hard disk, or the like.

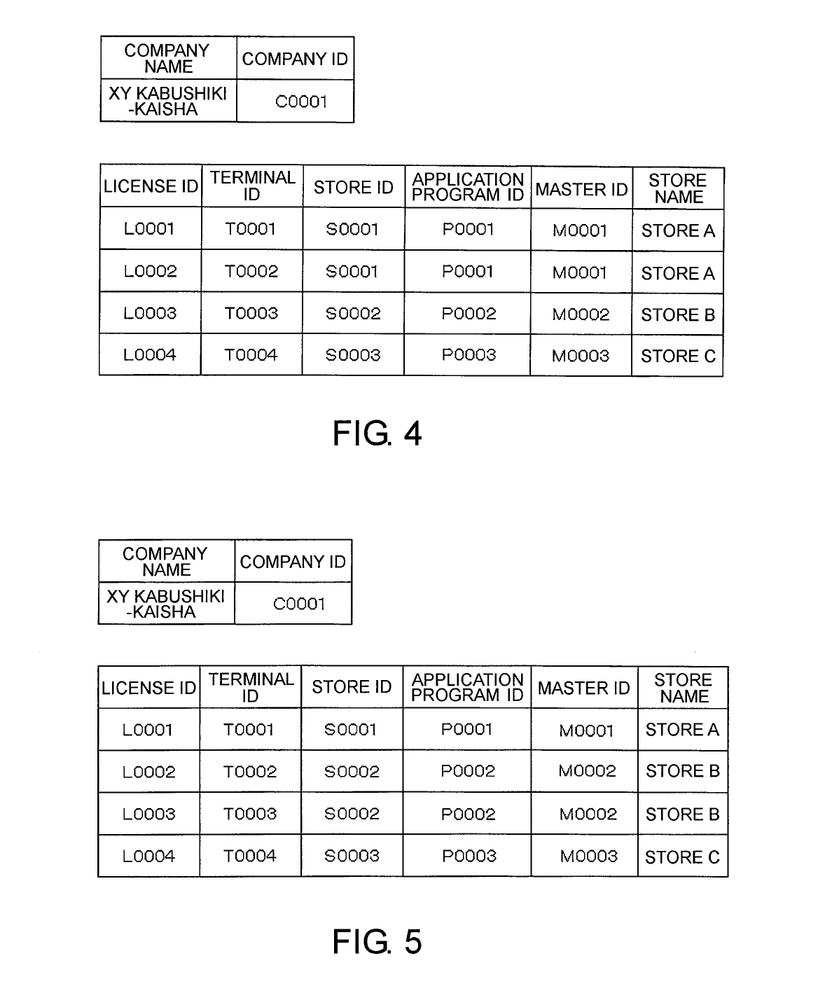

The memory unit 11 of the server 10 stores at least master data, an application program, and a table shown in FIG. 4.

Master data stored in the memory unit 11 may be master data for the POS device 20 and serves as basic information for use in execution of a business task on the POS device 20, and includes a price look up (PLU) file and the like, which are required for sales processing and the like to be executed on the POS device 20. Master data is set for each of the stores (in this embodiment, a store A, a store B, and a store C) of the user company.

The application program stored in the memory unit 11 is a program for the POS device 20, which is required for execution of the business task on the POS device 20 and causes the POS device 20 to execute the sales processing or the like. The application program is set for each of the stores (in this embodiment, the store A, the store B, and the store C) of the user company.

As shown in FIG. 4, in the table stored in the memory unit 11, for each “license ID (identification code)”, “terminal ID”, “store ID”, “application program ID”, “master ID”, and “store name” are registered in association with the “license ID”.

As used herein, the “license ID” refers to a unique code assigned by the supplier company of the POS devices 20 to each of the POS devices 20 that are licensed by the supplier company.

The “terminal ID” refers to a unique code for identifying each of the POS devices 20.

The “store ID” refers to a unique code for identifying each of the stores.

The “application program ID” refers to a unique code for identifying the application program for the POS device 20, which is set for each of the stores of the user company.

The “master ID” refers to a unique code for identifying master data for the POS device 20, which is set for each of the stores of the user company and includes the PLU files and the like required for the sales processing and the like to be executed on the POS device 20.

The “store name” refers to each store name of the user company, and in this embodiment, is one of the store A, the store B, and the store C.

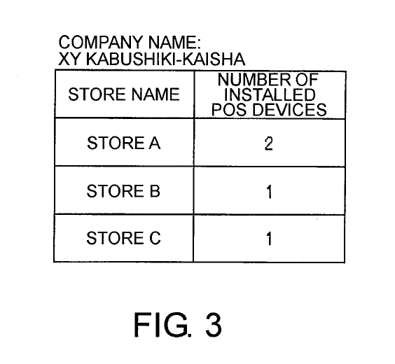

The table stored in the memory unit 11 is created by the supplier company based on information such as “company name”, “store name”, and “number of installed POS devices 20”, which are notified in advance from the company (user company) that desires to use the POS device 20 to the supplier company. FIG. 3 shows a part of such information, which is notified from the company (user company) that desires to use the POS device 20 to the supplier company.

As illustrated in FIG. 2, the control unit 12 of the server 10 includes an identification section 12a for referring, based on the “license ID” received from one of the POS devices 20 via the transmission/reception unit 14, to the table stored in the memory unit 11 to specify master data and the application program that are associated with the received “license ID”.

As illustrated in FIG. 2, the POS device 20 installed in each of the stores of the user company includes a memory unit 21, a control unit 22, an input unit 23, an output unit, a transmission/reception unit 24, an auxiliary storage device, and others. The control unit 22 is configured by a CPU or the like, and the memory unit 21 is configured by a ROM, a RAM, a hard disk, or the like. In the POS device 20, at the time of shipment, a setup program to be described later, an OS required for executing the setup program, and the like are installed.

The terminal 30 installed in the user company is configured by a general personal computer (PC) in this embodiment, and, as illustrated in FIG. 2, includes a memory unit 31, a control unit 32, an input unit 33, an output unit, a transmission/reception unit 34, auxiliary storage device, and others. The control unit 32 is configured by a CPU or the like, and the memory unit 31 is configured by a ROM, a RAM, a hard disk, or the like.

As illustrated in FIG. 2, the control unit 32 of the terminal 30 includes a modification section 32a for modifying a correspondence relationship or association between the “master ID” and each of the “application program ID” and the “license ID” of the table stored in the memory unit 11 of the server 10 via the communication network, when the POS device 20 that has been installed in one of the stores of the user company is relocated to another store. FIG. 5 shows a table obtained after the table shown in FIG. 4 is modified by the modification section 32a.

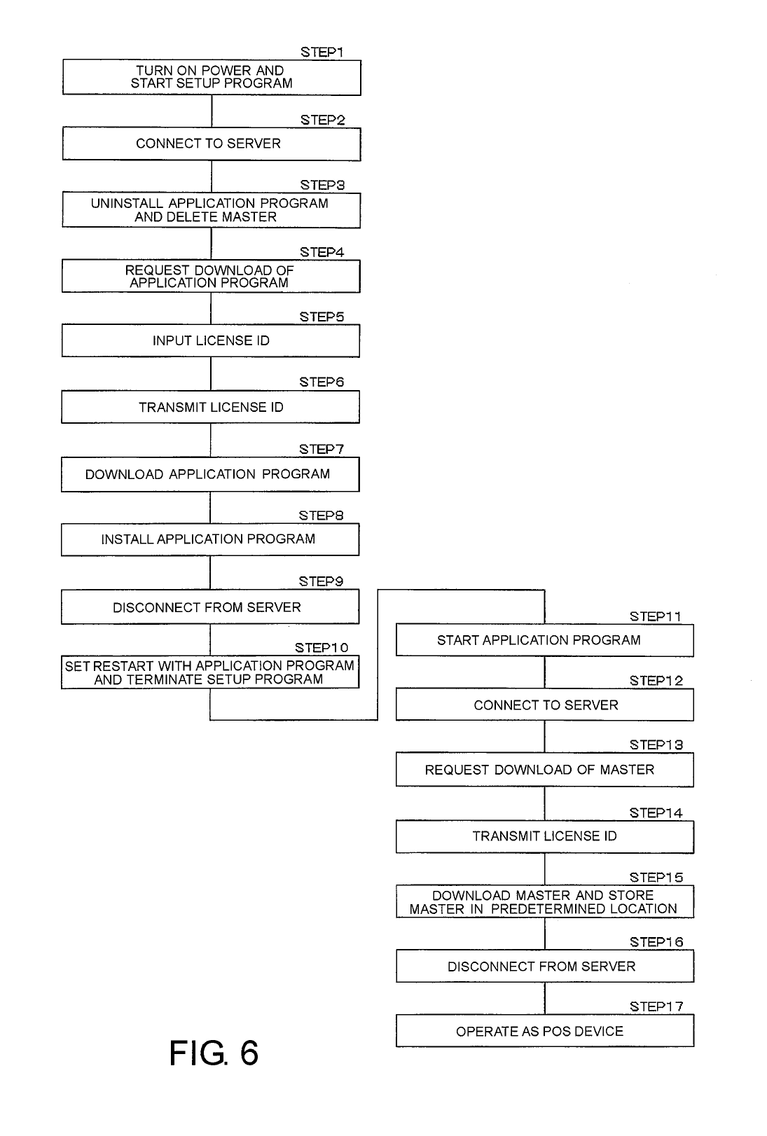

Next, referring to FIG. 6, a description is given below of a processing flow executed from a time when a new POS device 20 is installed in one of the stores of the user company to a time when the POS device 20 becomes available for use.

First, “license ID”, “terminal ID”, “store ID”, and “store name” for each POS device 20 are notified to the terminal 30 by e-mail or the like from the server 10.

Then, after the POS device 20 is carried into the store of the user company and the communication between the POS device 20 and the server 10 is established, a user performs the setup of the POS device 20 by following steps illustrated in FIG. 6. Note that, unless otherwise specified, each of the steps is executed by the setup program and the application program, which are installed in the POS device 20.

First, the user turns on the power of the POS device 20, and starts the setup program (STEP1). Note that, in the POS device 20, at the time of shipment, the setup program, the OS required for executing the setup program, and the like are installed.

Next, the POS device 20 is connected to the server 10 of the supplier company (STEP2). In this case, in the server 10 of the supplier company, an IP address of the POS device 20 allowed to connect the server 10 is registered in advance. Further, at the time of shipment, settings required for connecting to the server 10 of the supplier company are made on the POS device 20.

Next, the application program installed in the POS device 20 is uninstalled and master data is deleted (STEP3). Note that, STEP2 and STEP3 may be executed in reverse order.

Next, the POS device 20 requests, from the server 10 of the supplier company, a download of the application program stored in the memory unit 11 of the server 10 (STEP4).

Next, the user uses the input unit 23 of the POS device 20 to input the “license ID” (STEP5). At this time, the “license ID” input by the user is stored in the memory unit 21 of the POS device 20. Note that, in this embodiment, the input unit 23 of the POS device 20 is configured by a keyboard connected to the POS device 20, but any type of device may be used as a specific mode of the input unit 23.

Next, the “license ID” is transmitted from the POS device 20 to the server 10 via the transmission/reception unit 24 of the POS device 20 (STEP6).

Next, the server 10 verifies whether or not the “license ID” received from the POS device 20 via the transmission/reception unit 14 is the one registered therein. When the received “license ID” is the one registered therein, the server 10 refers to the table of FIG. 4 stored in the memory unit 11 to specify the application program associated with the “license ID”, and while specifying the application program, allows the download of the specified application program. Further, at this time, the “terminal ID” and the “store ID” are transmitted from the server 10 to the POS device 20. The POS device 20 stores the “terminal ID” and the “store ID”, and downloads the specified application program (STEP7).

Next, the downloaded application program is installed (STEP8).

Next, the POS device 20 is disconnected from the server 10 (STEP9).

Next, a restart with the installed application program is set, and the setup program is terminated (STEP10).

Next, the POS device 20 starts the installed application program (STEP11).

Next, the POS device 20 verifies whether or not master data is stored in the memory unit 21. Master data is not stored, and hence in order to download master data, the POS device 20 is connected to the server 10 of the supplier company (STEP12).

Next, the POS device 20 requests a download of master data from the server 10 (STEP13).

Next, the “license ID” stored in the memory unit 21 of the POS device 20 is transmitted from the POS device 20 to the server 10 (STEP14).

Next, the server 10 verifies whether or not the “license ID” received from the POS device 20 is the one registered therein. When the received “license ID” is the one registered therein, the server 10 refers to the table of FIG. 4 stored in the memory unit 11 to specify master data associated with the “license ID”, and while specifying master data, allows the download of the specified master data. The POS device 20 downloads specified master data, and stores the downloaded master data in the memory unit 21 (STEP15).

Next, the POS device 20 is disconnected from the server 10 (STEP16).

Next, the above-mentioned POS device 20 operates as the POS device 20 (STEP17).

In this manner, the POS device 20 becomes available for use through STEP1 to STEP17 described above.

Next, a description is given in the case where the POS device 20 that has been installed and operated in a given store (for example, the store A) of the user company is relocated to another store (for example, the store B) of the user company and operated, to a time when the POS device 20 becomes available for use at the store (the store B) as the relocation destination.

First, the user who desires to relocate the POS device 20 logs in to the server 10 from the terminal 30 with use of an “ID” and a “password” that are notified to the user in advance, and in the table stored in the memory unit 11 of the server 10, modifies the “store ID”, the “application program ID”, the “master ID”, and the “store name” associated with the “license ID” of the POS device 20 to be relocated. Note that, in the server 10 of the supplier company, an IP address of the terminal 30 allowed to connect the server 10 is registered in advance.

FIG. 5 shows a table obtained after the table shown in FIG. 4 is modified by the modification section 32a of the terminal 30. FIG. 4 and FIG. 5 show an example in which the POS device 20 having “L0002” as the “license ID” is relocated from the store A to the store B. In the tables, the “store ID”, the “application program ID”, the “master ID”, and the “store name” of the POS device 20 having “L0002” as the “license ID” are modified.

Next, after the above-mentioned modification of the table is finished, the POS device 20 is carried into the store (the store B) as the relocation destination, and the communication between the POS device 20 and the server 10 is established, the user performs setup at the time of relocation of the POS device 20.

Steps of the setup at the time of relocation of the POS device 20 are substantially the same as the steps of the setup at the time of installing the new POS device 20, and the setup program to be used for the setup is also the same. However, the “license ID” is already stored in the memory unit 21 of the POS device 20, and hence STEPS of FIG. 5 is skipped and the “license ID” is transmitted to the server 10.

In this manner, the POS device 20 becomes available for use at the store (the store B) as the relocation destination.

In this embodiment obtained in this way, the user can perform the setup at the time of installing the new POS device 20 in the store or at the time of relocating the POS device 20, and hence a cost of the installation of the new POS device 20 or the relocation of the POS device 20 can be reduced. Moreover, a workload of the supplier company can be reduced, which benefits the supplier company as well. For example, the supplier company does not need to adjust a schedule of the installation work.

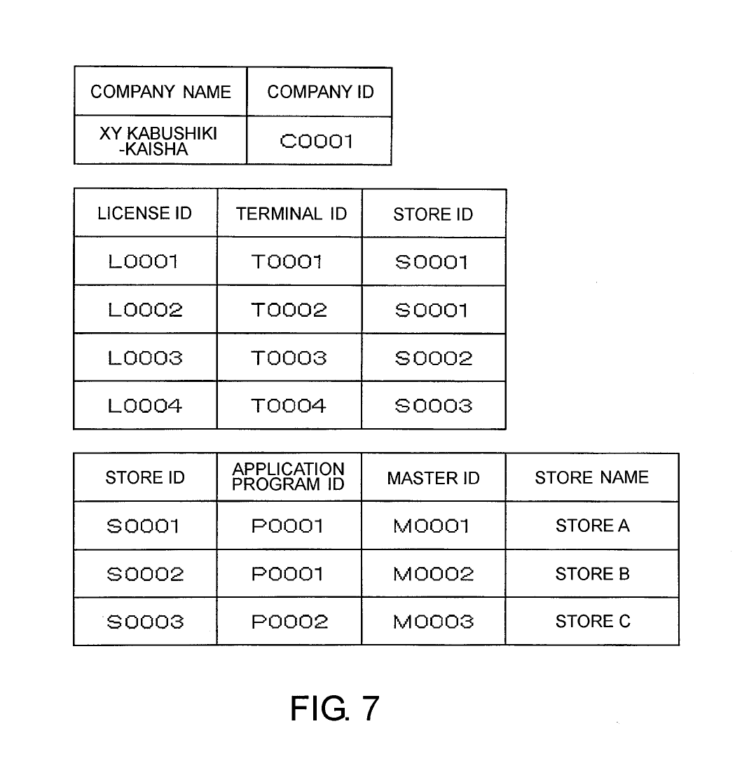

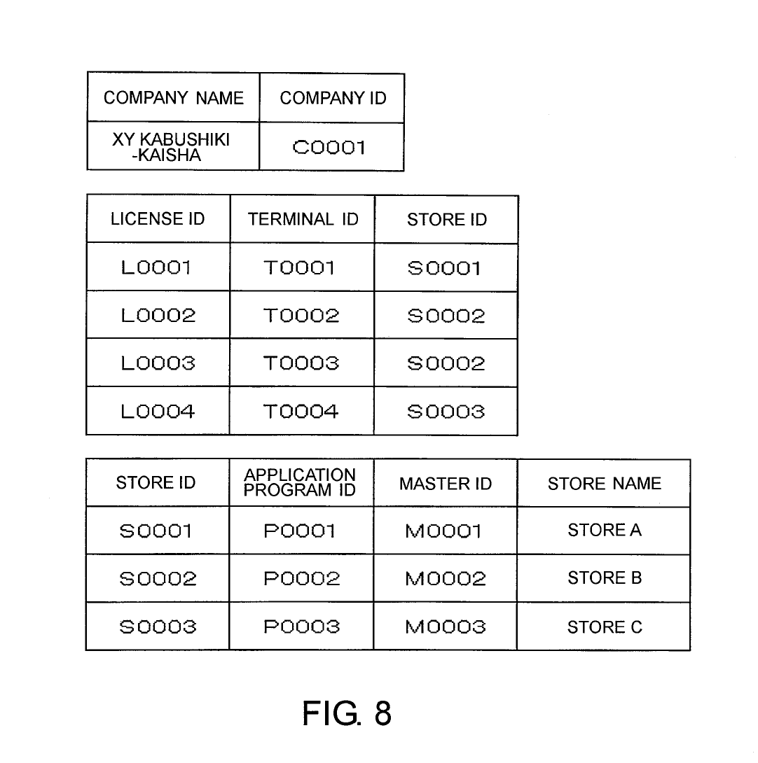

Next, referring to FIG. 7 and FIG. 8, a description is given of a system according to a second embodiment of this invention.

The first embodiment and the second embodiment of this invention have only the following three differences, and hence only the differences from the first embodiment are described.

First, as a first difference, the structure of the table stored in the memory unit 11 of the server 10 differs between the first embodiment and the second embodiment.

Specifically, in the table of the first embodiment, as shown in FIG. 4, for each “license ID”, the “terminal ID”, the “store ID”, the “application program ID”, the “master ID”, and the “store name” are associated with the “license ID”. In contrast, as shown in FIG. 7, tables of the second embodiment configure a first table in which, for each “license ID”, the “terminal ID” and “ the store ID” are associated with the “license ID” and a second table in which, for each “store ID”, the “application program ID”, the “master ID”, and the “store name” are associated with the “store ID”.

Next, as a second difference, the method of specifying, by the identification section 12a of the server 10, the “application program ID” and the “master ID” differs between the first embodiment and the second embodiment.

Specifically, in the second embodiment, after the server 10 receives the “license ID” from the POS device 20, the server 10 first refers to the first table to specify the “store ID” associated with the “license ID”, and further refers to the second table to specify the “application program ID” and “the master ID” that are associated with the “store ID”.

Next, as a third difference, what is modified in the table at the time of relocating the POS device 20 with use of the modification section 32a of the terminal 30 differs between the first embodiment and the second embodiment.

Specifically, in the second embodiment, when relocating the POS device 20, the user modifies only the “store ID” associated with the “license ID” via the modification section 32a of the terminal 30. FIG. 8 shows a table obtained after the table shown in FIG. 7 is modified in order to relocate the POS device 20. FIG. 7 and FIG. 8 show an example in which the POS device 20 having “L0002” as the “license ID” is relocated from the store A to the store B, and the “store ID” associated with the “license ID” is modified to “S0002”.

In the second embodiment obtained in this way, in addition to the effects of the first embodiment, the user needs to modify only the “store ID” associated with the “license ID” at the time of relocating the POS device 20, and hence the workload of the user relating to the relocation of the POS device 20 can be reduced.

Next, a description is given below of a system according to a third embodiment of this invention.

The third embodiment differs from the first and second embodiments described above in that only master data differs for each store of the user company and the same application program is used in common among the each of the stores of the user company. In the following, a description is given only of a difference between the first and second embodiments and the third embodiment.

First, in the system of the third embodiment, while master data differs for each store of the user company, the same application program is used in common among the each of the stores of the user company.

Further, in the descriptions of the first and second embodiments given above, the application program is downloaded from the server 10 in STEP7 of FIG. 6 and the application program is installed in the POS device 20 in STEP8 of FIG. 6, but in the third embodiment, the setup program is programmed so that the POS device 20 is inhibited from downloading the application program from the server 10, and at the time of shipment, the application program is installed in advance in the POS device 20.

Further, in the third embodiment, the same application program is used in common among the each of the stores of the user company, and hence all the “application program IDs” of the tables shown in FIG. 4, FIG. 5, FIG. 7, and FIG. 8 are the same.

Note that, in the descriptions of the first, second, and third embodiments given above, the “license ID” is used as the identification code for uniquely specifying the POS device, but another type of code may be used as long as the code can be used to uniquely specify the POS device.

Further, in the first, second, and third embodiments described above, the setup program is used to download the application program to be installed in the POS device and then the application program is started to download master data, but instead of starting the application program to download master data, the setup program may be used to download master data in the same manner as in the case of the application program.

This application claims priority from Japanese Patent Application No. 2012-041501, filed on Feb. 28, 2012, the entire disclosure of which is incorporated herein.

### REFERENCE SIGNS LIST

10 server
11 memory unit (memory means)
12 control unit
12a identification section (identification means)
13 input unit
14 transmission/reception unit (transmission/reception means)
20 POS device
21 memory unit
22 control unit
23 input unit (input means)
24 transmission/reception unit (transmission/reception means)
30 terminal
31 memory unit
32 control unit
32a modification section (modification means)
33 input unit
34 transmission/reception unit

1. A system, comprising:
a server installed in a supplier company of POS devices; and
the POS devices which are to be installed in stores of a user company of the POS devices and to be connected to the server via a communication network, and
a terminal which is to be installed in the user company and to be connected to the server via the communication network, wherein:
each of the POS devices comprises:
an input unit for inputting an identification code for uniquely identifying the each of the POS devices; and
a transmission/reception unit; and
the server comprises:
a memory unit for storing a table in which master data set for each of the stores of the user company is associated with the identification code;
a reception unit for receiving the identification code from the each of the POS devices;
an identification section for referring to the table to identify the master data associated with the received identification code; and
a transmission unit for transmitting the identified master data to the each of the POS devices; and
the terminal comprises:
a modification section for modifying a correspondence relationship of the table between the master data and the identification code via the communication network, when one of the POS devices that has been installed in one of the stores of the user company is relocated to another of the stores.

2. A system according to claim 1, wherein:
the table makes the identification code correspond to an application program and the master data set for the each of the stores of the user company;
the identification section specifies master data and application program that correspond to the identification code received by the reception unit; and
the transmission unit transmits the specified master data and application program to the each of the POS devices.

3. (canceled)

4. A system according to claim 1, wherein the table comprises at least a first table in which the identification code is associated with the each of the stores of the user company and a second table in which the each of the stores of the user company is associated with the master data.

5. (canceled)

6. A method of controlling a system,
the system comprising:
a server installed in a supplier company of POS devices;
the POS devices installed in stores of a user company of the POS devices and connected to the server via a communication network, and
a terminal installed in the user company and connected to the server via the communication network,
the method comprising:
transmitting an identification code for uniquely specifying the each of the POS devices to the server through a transmission/reception unit of each of the POS devices to the server;
referring, by an identification section of the server, to a table stored in a memory unit of the server, in which master data set for each of the stores of the user company is associated with the identification code, to specify master data associated with the identification code received from the each of the POS devices; and
transmitting, by a transmission unit of the server, the specified master data to the each of the POS devices; and
modifying a correspondence relationship of the table between the master data and the identification code via the communication network by the use of a modification section of the terminal, when one of the POS devices that has been installed in one of the stores of the user company is relocated to another of the stores.

7. (canceled)
